(19) United States
(12) Patent Application Publication
(10) Pub. No.: US 2017/0193737 A1
(43) Pub. Date: Jul. 6, 2017

(54) ELECTRONIC DEVICE FOR PLAYING BINGO AND METHOD

(71) Applicant: Diane De Cicco, Brooklyn, NY (US)

(72) Inventor: Diane De Cicco, Brooklyn, NY (US)

(21) Appl. No.: 15/396,813

(22) Filed: Jan. 2, 2017

Related U.S. Application Data
(60) Provisional application No. 62/274,256, filed on Jan. 2, 2016.

(51) Int. Cl. G07F 17/32

(52) U.S. Cl. CPC G07F 17/329; G07F 17/3211; G07F 17/3209; G07F 17/3244; G07F 17/3225

(57) ABSTRACT

An electronic device for playing bingo. The electronic device for playing bingo includes a mobile device housing, a transceiver embedded in the mobile device housing and configured to communicate over a wireless communication link, a user-player interface fixed to the mobile device housing and including an interactive display, a manual data entry subsystem configured to provide for the user-player to input information in the system manually, a memory embedded in the mobile device housing, and configured to store an executable mobile application, the executable mobile application configured to interact with a processor embedded in the housing and communicably coupled to the transceiver. The memory, the user-player interface, and the processor are configured to execute the executable mobile application responsive to s user-player interaction with the user-player interface. Also included is an electronic device stand configured to provide user-player accessible interaction and viewing functions.

### CROSS-REFERENCE TO RELATED APPLICATION

The present application is related to and claims priority to U.S. Provisional Patent Application No. 62/274,256 filed Jan. 2, 2016, which is incorporated by reference herein in its entirety.

### BACKGROUND OF THE INVENTION

The following includes information that may be useful in understanding the present disclosure. It is not an admission that any of the information provided herein is prior art, nor material to the presently described or claimed inventions, nor that any publication or document that is specifically or implicitly referenced is prior art.

1. Field of the Invention

The present disclosure relates generally to the field of amusement devices and games, and more specifically relates to electronic amusement devices and games.

2. Description of Related Art

Generally, bingo is a game of chance played with different randomly drawn numbers which players match against numbers that have been pre-printed on 5×5 cards. The 5×5 cards may be printed on paper or card stock, or electronically represented, and are referred to as cards. Many versions conclude the game when the first person achieves a specified pattern from the drawn numbers. The winner is usually required to call out the word “Bingo!”, which alerts the other players and caller of a possible win. All wins are checked to make sure the person has not made a mistake before the win is officially confirmed at which time the prize is secured and a new game is begun.

In conventional bingo there are two methods of play. The first involves purchasing cardboard cards which are marked with either plastic chips or coins. The risk that a breeze or other disturbance can move the chips and, in effect ruin that particular game for the player. The second method of play is to purchase special paper versions which are marked by an ink blotter which causes clutter and must be disposed of at the end of the game thus creating waste. A suitable solution is desired for both methods.

Several attempts have been made to solve the above-mentioned problems such as those found in U.S. Pat. No. 8,128,089 to Erickson, U.S. Pat. No. 7,708,632 to Lind et al., U.S. Pat. No. 8,740,686 to Khal, U.S. Pub. No. 2013/0079115 to Nelson, and U.S. Pub. No. 2015/0141110 to Gupta et al. These references are representative of electronic amusement devices and games. However, none of the above references, taken either singly or in combination, is seen to describe the invention as claimed.

U.S. Pub. No. 2015/0141110 to Gupta et al. relates to a system and method for allowing players to play matching games having symbol groups including a system for allowing players to play a bingo-type game with a user-player computing device. There, the system includes a database including a plurality of bingo symbols and a system controller coupled to the database. The system controller is arranged to receive a request from a player to play the bingo-type game and responsively display the bingo-type game on the at least one user-player computing device. The system controller is arranged to determine a plurality of symbol groups included in the bingo-type game, randomly select a set of bingo symbols, and displays the selected set of bingo symbols with respect to the symbol grid. Each symbol group includes a predefined set of bingo symbols. The set of bingo symbols includes a bingo symbol selected from each one of the symbol groups. Each bingo symbol in the set of bingo symbols is displayed.

### BRIEF SUMMARY OF THE INVENTION

In view of the foregoing disadvantages inherent in the known electronic amusement devices and games art, the present disclosure provides a novel electronic device for playing bingo. The general purpose of the present disclosure, which will be described subsequently in greater detail, is to provide an electronic device for playing bingo.

An electronic device for playing bingo is disclosed herein. The electronic device for playing bingo includes a portable electronic device and an electronic device stand arranged to provide user-player accessible interaction and viewing functions. The electronic device for playing bingo includes a mobile device housing, a transceiver embedded in the mobile device housing and arranged to communicate over a wireless communication link, a user-player interface fixed to the mobile device housing and including an interactive display, and a manual data entry subsystem to provide for the user-player to manually interact with the electronic device. The electronic device for playing bingo further includes a memory embedded in the mobile device housing, and arranged to store an executable mobile application, the executable mobile application is arranged to provide at least one prenumbered bingo card to a user-player-player, to provide an indice of remaining currency amounts to the user-player-player, to provide an indice of the prize currency to the user-player, to play at least a portion of the remaining currency available to the user-player on the at least one prenumbered bingo card, and to execute a display of the value of the most recent bingo ball drawn during commencement of the game as transmitted over the wireless communication link from a central gaming module. The memory includes a removable memory device for storing portable data associated with the mobile application. The electronic device for playing bingo further includes a processor embedded in the housing and communicably coupled to the transceiver, the memory, and the user-player interface. The processor embedded in the housing and communicably coupled to the transceiver, the memory, the user-player interface, and the processor are arranged to execute the mobile application responsive to user-player interaction along with the user-player interface, to selectably execute said ball value display option, to selectably execute a remaining currency amount option, to selectably execute a prize currency option, and to selectably execute the recent bingo ball drawn option.

The electronic display device and the removable memory card work together in functional combination to display the prenumbered bingo card. According to another embodiment, an electronic device for playing bingo is also disclosed herein where the removable memory card contains a plurality of prenumbered bingo cards.

The electronic device for playing bingo includes a method of use including inserting the removable memory card into the electronic device for playing bingo, activating the electronic device for playing bingo via multipurpose switch, participating in a game of bingo using the electronic device for playing bingo, and transmitting the amount of money that remains on the player's card from the electronic device for playing bingo to a printer. The method of use may further include the steps of charging the electronic device for playing bingo and programming the removable memory card with information pertinent to the current game values.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an electronic device for playing bingo, constructed and operative according to the teachings of the present disclosure.

FIG. 1 is a perspective view of the electronic device for playing bingo during an ‘in-use’ condition, according to an embodiment of the disclosure.

FIG. 2 is schematic diagram of a system for playing bingo using the electronic device for playing bingo of FIG. 1, during an ‘in-use’ condition according to an embodiment of the present disclosure.

FIG. 3 is a perspective view of the electronic device for playing bingo of FIG. 1, according to an embodiment of the present disclosure.

FIG. 4 is a schematic block diagram of the electronic device for playing bingo of FIG. 1, according to an embodiment of the present disclosure.

FIG. 5 is a flow diagram illustrating a method the experience of playing bingo according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an electronic amusement devices and games and more particularly to an electronic device for playing bingo as used to improve the experience of playing of bingo.

In this version of bingo, players compete against one another for the prize or jackpot. Generally speaking, the present disclosure eliminates the need to use cardboard chips or messy ink blotters and ensures that the hard of hearing don't miss a single number by displaying each ball that is called. In particular the disclosure saves time by eliminating the need to wait in line for a bingo card and utilizes a separate player's card that a user-player can pre-load with money. The present disclosure allows a person to mark their card's numbers quickly and without fear that a marker may shift. The disclosure also offers the advantage of portability of the electronic device.

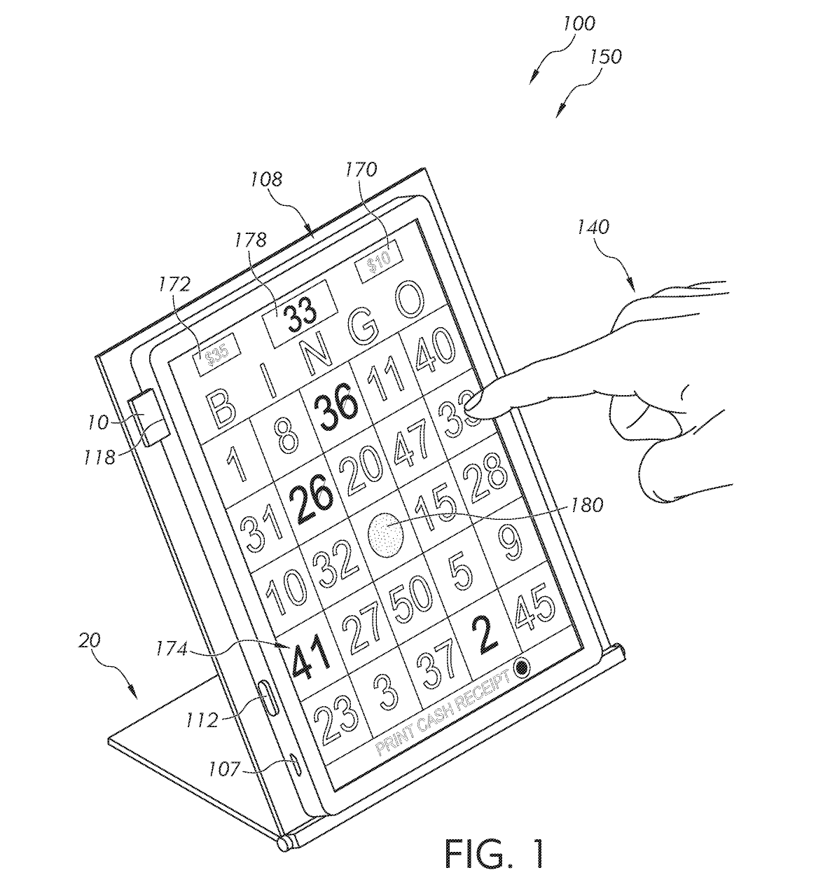

Referring now more specifically to the drawings by numerals of reference, there is shown in FIGS. 1-4, various views of an electronic device for playing bingo 100. FIG. 1 shows an electronic device for playing bingo during an ‘in-use’ condition 150, according to an embodiment of the present disclosure. Here, the electronic device for playing bingo 100 may be beneficial for use by a user-player 140 to receive and record the value of the “called bingo” ball electronically as indicated by the indice of most recent bingo ball drawn value 178. As illustrated, the electronic device for playing bingo 100 may include an electronic device stand 20.

The electronic device for playing bingo 100 may include a removable memory device 10, an electronic device stand 20, a charging port 107, a mobile device housing 108, a multipurpose activation button 112, a memory slot 118, an indice of remaining currency 170, an indice of prize currency 172, an image of prenumbered bingo card 174, an indice of most recent bingo ball drawn value 178, and a mark displayed for bingo balls drawn 180.

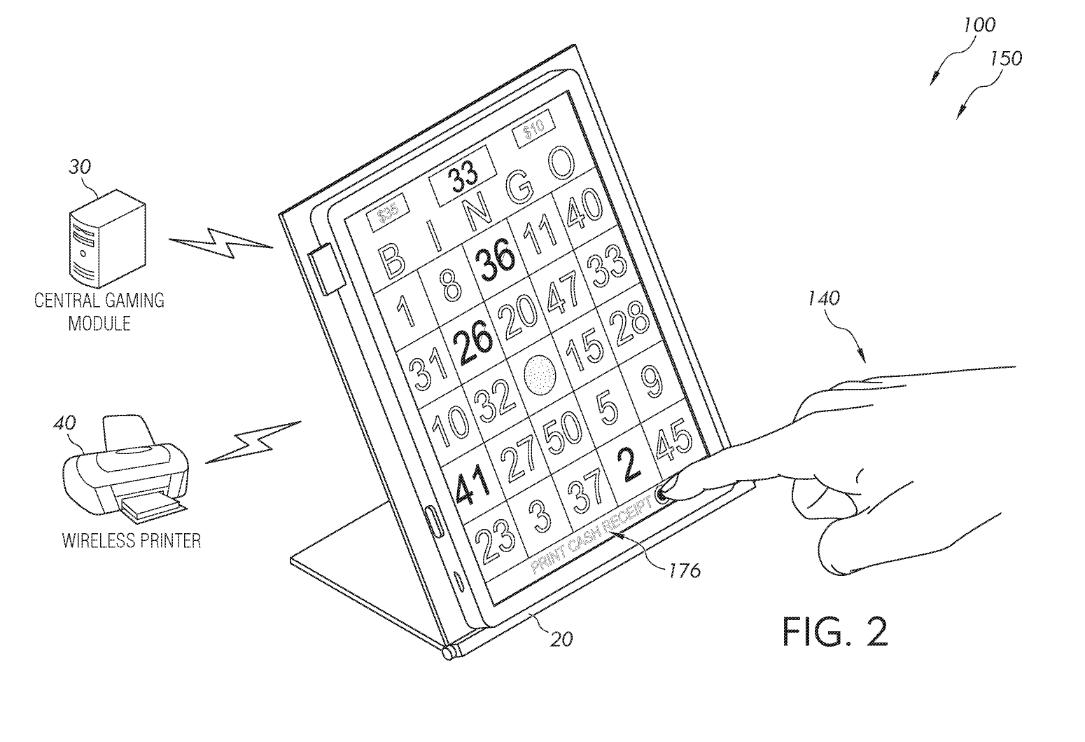

FIG. 2 is schematic diagram of a system for playing Bingo using the electronic device for playing bingo of FIG. 1, during an ‘in-use’ condition according to an embodiment of the present disclosure. As above, the electronic device for playing bingo 100 may include the ability to communicate via wireless interface to a central gaming module 30 and a wireless printer 40. User-player 140 may have the option to select to print winnings via an image of “PRINT CASH RECEIPT” 176 image (or the like) on an interactive display 162.

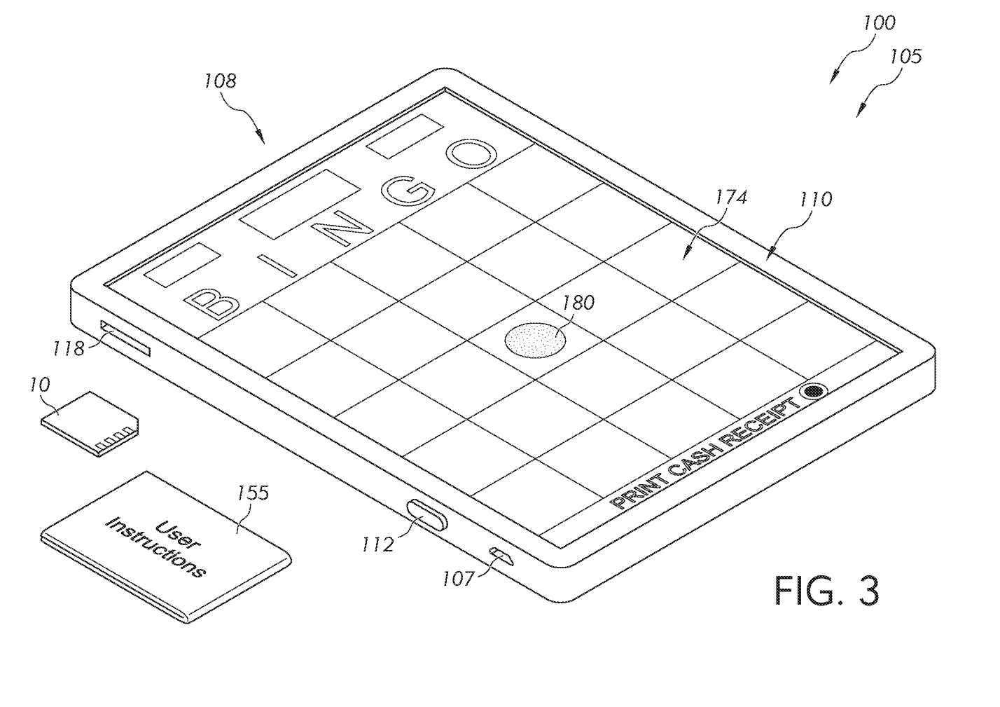

FIG. 3 is a perspective view of the electronic device for playing bingo 100 of FIG. 1, according to an embodiment of the present disclosure illustrating the electronic display device 110, the charging port 107, the mobile device housing 108, a multipurpose activation button 112, the memory slot 118, and removable memory device 10. Also shown in FIG. 3 of prenumbered bingo card 174 and a mark displayed for bingo balls drawn 180.

The mobile device housing 108 provides structure and support for the electronic display device 110, a multipurpose activation button 112, the charging port 107, and the memory slot 118. The multipurpose activation button 112, is used to power the device on and off as well as perform additional functions such as scrolling through various images of prenumbered bingo cards 174.

According to one embodiment, the electronic device for playing bingo 100 may be arranged as a kit 105. In particular, the electronic device for playing bingo 100 may further include a set of instructions 155. The instructions 155 may detail functional relationships in relation to the structure of the electronic device for playing bingo 100 (such that the electronic device for playing bingo 100 can be used, maintained, or the like, in a preferred manner).

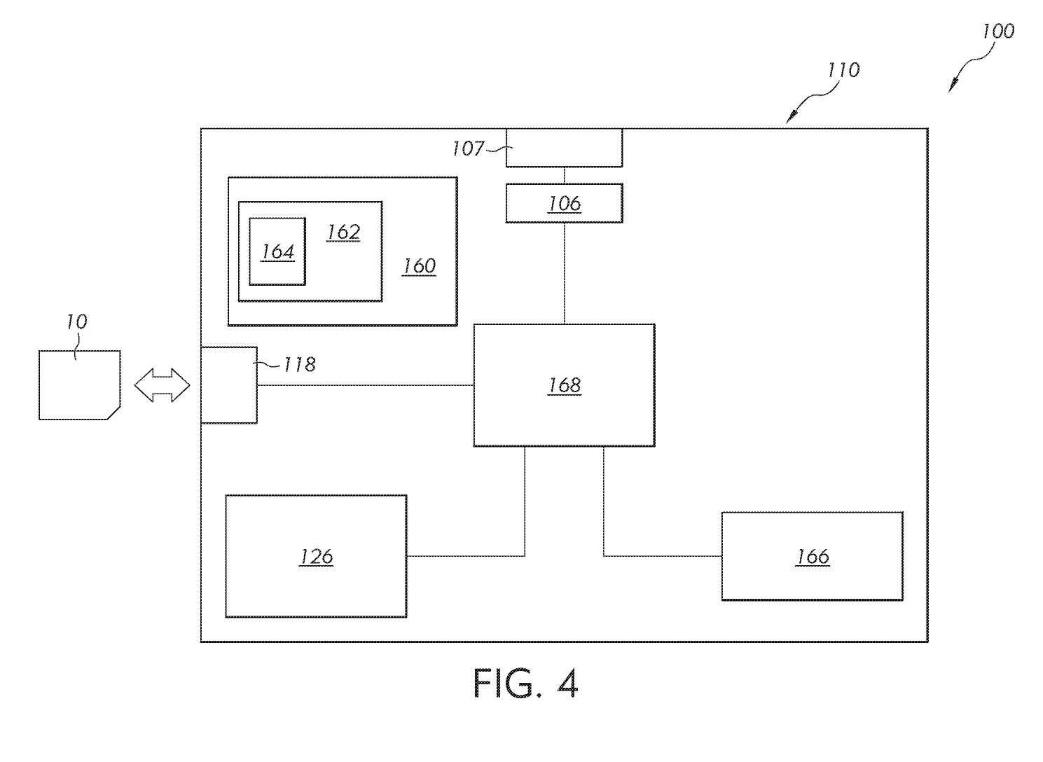

FIG. 4 is a schematic block diagram of the electronic device for playing bingo 100 of FIG. 1, according to an embodiment of the present disclosure. As above, the electronic device for playing bingo 100 includes the removable memory device 10, and the electronic display device 110. Likewise, the electronic display device 110 includes the mobile device housing 108, the memory slot 118, the user-player interface 160 (including the interactive display 162 and the manual data entry subsystem 164). As shown, the electronic display device 110 may further include internal components including an embedded processor 168, an embedded memory 126, a transceiver 166, a rechargeable power source 106, and the charging port 107.

The embedded processor 168, the embedded memory 126, and transceiver 166 are fixed to and embedded in the mobile device housing 108. As shown the embedded processor 168, the embedded memory 126, and transceiver 166 are communicably coupled, and are powered by at least one of the rechargeable power source 106, and the charging port 107. In addition, the transceiver 166 is configured to communicate over a wireless communication link. When inserted into the memory slot 118, the removable memory device 10 is electrically connected and communicably coupled to all or some of the embedded memory 126, the embedded processor 168, the transceiver 166, the user interface 160, the interactive display, and the manual data entry subsystem 164.

As above, the electronic device for playing bingo 100 includes the user-player interface 160 fixed to the mobile device housing 108. The user-player interface 160 may include the interactive display 162 and the manual data entry subsystem 164, configured in a manner to provide for a user-player 140 to manually interact with the electronic display device 110 to input information in the system. The inputted information may be processed by embedded processor 168, and thus enable the user-player 140 to create a mark displayed for bingo balls drawn 180.

The components shown are communicably coupled to store an executable mobile application, whereas the executable mobile application provides at least one image of a prenumbered bingo card 174 to a user-player 140, in addition to providing indice of remaining currency 170 amount, an indice of the prize currency 172, and to execute a display indice of most recent bingo ball drawn value 178. The displayed indice of most recent bingo ball drawn value 178 is received via the transceiver 166 over the wireless communication link via transceiver 166 thus alerting the user-player 140 to the value as transmitted from central gaming module 30 (FIG. 3).

The overall system memory includes removable memory device 10 and embedded memory 126. The memory portion of the electronic device for playing bingo 100 includes portable data associated with the mobile application and communicates internally with embedded processor 168 located in the mobile device housing 108 and communicably coupled to the transceiver 166.

The embedded memory 126, the user-player interface 160, and the embedded processor 168 are arranged to execute the executable mobile application responsive to said user-player 140 interaction with user-player interface 160 to selectably execute and display said indice of most recent bingo ball drawn value 178 option, to selectably execute and display indice of remaining currency 170 display option, to selectably execute and display indice of prize currency 172, and to selectably execute and display indice of most recent bingo ball drawn value 178 display option.

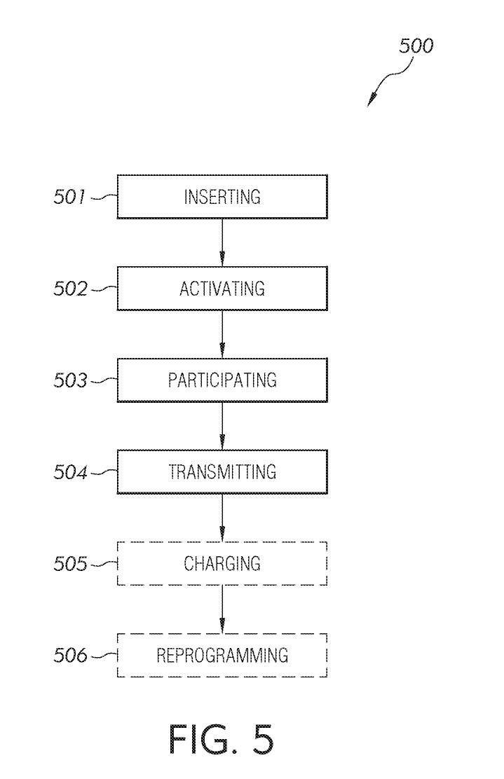

FIG. 5 is a flow diagram illustrating a method for electronically playing bingo, according to an embodiment of the present disclosure. In particular, the method for electronically playing bingo 500 may include one or more components or features of the electronic device for playing bingo 100 as described above.

As illustrated, the method for electronically playing bingo 500 may include the steps of step one 501, inserting the removable memory device into the electronic device for playing bingo; step two 502, activating the electronic device for playing bingo via multipurpose activation button; step three 503, participating in a game of bingo using the electronic device for playing bingo; and step four 504, transmitting the amount of money that remains on the player's card from the electronic device for playing bingo to a wireless printer.

The method of use 500 may also include the steps of step five 505, charging the electronic device for playing bingo and step six 506 programming the removable memory card with information pertinent to the current game values. It should be noted that steps 505 and 506 are optional step and may not be implemented in all cases. Optional steps of method of use 500 are illustrated using dotted lines in FIG. 5 so as to distinguish them from the other steps of method of use 500.

It should also be noted that the steps described in the method of use can be carried out in many different orders according to user-player preference. The use of “step of” should not be interpreted as “step for”, in the claims herein and is not intended to invoke the provisions of 35 U.S.C. §112(f). It should also be noted that, under appropriate circumstances, considering such issues as design preference, user-player preferences, marketing preferences, cost, structural requirements, available materials, technological advances, etc., other methods for electronically playing bingo (e.g., different step orders within above-mentioned list, elimination or addition of certain steps, including or excluding certain maintenance steps, etc.), are taught herein.

The embodiments of the invention described herein are exemplary and numerous. Modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electronic device for playing bingo, the electronic device comprising:
a mobile device housing;
a transceiver embedded in the mobile device housing and configured to communicate over a wireless communication link;
a user-player interface fixed to the mobile device housing, and including an interactive display and a manual data entry subsystem, the user-player interface configured to provide for a user-player to manually interact with electronic device;
a memory embedded in the mobile device housing, and configured to store an executable mobile application, the executable mobile application configured
to display at least one prenumbered bingo card on the interactive display,
to indicate remaining currency available to the user-player to play with,
to indicate prize currency available to a winner,
to play at least a portion of the remaining currency available to the user-player on the at least one prenumbered bingo card, and
to indicate a bingo ball drawn as received by the transceiver over the wireless communication link;
a processor embedded in the housing and communicably coupled to the transceiver, the memory, and the user interface, the processor configured to execute the executable mobile application responsive to said user interaction with the user interface; and
a removable memory device configured to store portable data associated with the executable mobile application;
an electronic device stand configured to support the electronic device in an upright orientation.

2. The electronic device claim 1, wherein the removable memory device contains at least one prenumbered bingo card.

3. The electronic device of claim 2, wherein the interactive display is configured to display the prenumbered bingo card contained in the removable memory device.

4. The electronic device of claim 1, wherein the interactive display is configured to display and mark a number on the prenumbered bingo card display that matches the bingo ball as received by the transceiver.

5. The electronic device of claim 4, wherein the transceiver communicates with a central gaming module over the wireless communication link.

6. The electronic device of claim 1, further comprising a multifunction switch configured to power the electronic device on and off.

7. The electronic device of claim 1, further comprising a charging port.

8. The electronic device of claim 7, wherein the charging port is a USB connector.

9. The electronic device of claim 1, further comprising a rechargeable power source.

10. The electronic device of claim 1, wherein the interactive display is configured to indicate a winning achievement by displaying “BINGO”.

11. The electronic device of claim 10, wherein the remaining currency available to the user-player to play with can be transferred to a cashier and made available the user-player as a cash out.

12. The electronic device of claim 10, wherein at least the portion of the remaining currency played on the at least one prenumbered bingo card can be transmitted as a file that can be received by an electronic printer.

13. The electronic device of claim 1, wherein the removable memory device contains a plurality of prenumbered bingo cards.

14. The electronic device of claim 1, wherein the user interface and removable memory device are configured to work in a manner that allows the user to scroll between a plurality of prenumbered bingo cards.

15. The electronic device of claim 1, wherein the removable memory device is a flash drive.

16. The electronic device of claim 1, wherein the removable memory device is an SD card.

17. An electronic amusement devices: games system, the electronic device for playing bingo comprising:
an electronic display device; containing
an interactive display,
an electronics control module,
a memory slot,
a rechargeable power source,
a power source connector,
a multipurpose activation button, and
an external case for containing and providing support for the interactive display, electronics control module, memory slot, rechargeable power source, power source connector, and a multipurpose activation button, and
a removable memory card removably coupleable to the electronic display device, the second element including
an electronic assembly having a
physical memory circuit, and
a male memory module connector electrically connected together, and
an electronic device stand configured to provide user accessible interaction and viewing functions,
wherein the removable memory card contains at least one prenumbered bingo card,
wherein the electronic display device and the removable memory card work together in functional combination to display the prenumbered bingo card,
wherein the electronic display device has wifi communication capability,
wherein the wifi communication capability interacts with a central gaming module,
wherein the interactive display displays the value of the most recent bingo ball drawn during commencement of the game as transmitted via wifi,
wherein the interactive display enables a user to record and display the value of the most recent bingo ball drawn during commencement of the game,
wherein the interactive display displays the amount of money that remains on the player's card,
wherein the interactive display indicates the amount of the current prize currency,
wherein the interactive display indicates a winning achievement by displaying BINGO,
wherein the amount of money that remains on the player's card can be electrically transmitted in order to enable the user to “cash out”,
wherein the amount of money that remains on the player's card is transmitted as a file that can be received by an electronic printer, and
wherein the removable memory card can be an SD card.

18. The electronic device of claim 17, further comprising set of instructions; and
wherein the electronic device is arranged as a kit.

19. A method of use for an electronic device for playing bingo, the method comprising the steps of:
inserting a removable memory card into the electronic device for playing bingo;
activating the electronic device for playing bingo;
participating in a game of bingo using the electronic device for playing bingo; and
transmitting an amount of money that remains on a player's card from the electronic device for playing bingo to a printer

20. The method of claim 19, further comprising the steps of:
charging a removable memory card into the electronic device for playing bingo; and
programming the electronic device for playing bingo with information pertinent to current game values.
